(19) United States
(12) Patent Application Publication
(10) Pub. No.: US 2004/0003901 A1
(43) Pub. Date: Jan. 8, 2004

(54) Control box for vertical blind

(76) Inventors: His-Hui Nien, Changhua (TW); Ching-Chuan Huang, Changhua (TW)

Correspondence Address: BACON & THOMAS, PLLC, 625 SLATERS LANE, FOURTH FLOOR, ALEXANDRIA, VA, 22314

(21) Appl. No.: 10/188,797

(22) Filed: Jul. 8, 2002

(51) Int. Cl. E06B 9/36

(52) U.S. Cl. 160/168.1 V

(57) ABSTRACT

The present invention is to provide a control box adapted to be installed in a headbox of a vertical blind. The vertical blind has a rotatable tooth axle on which a set of carriers are mounted, a plurality of slats respectively coupled to the carriers, and a control rod pivoted to the control box for controlling the rotation of the slats. The control box has a lower part thereof tilted to keep the control rod away from the adjacent slat at a distance, preventing contact of the adjacent slat with the control rod during rotary motion of the slats.

### BACKGROUND OF THE INVENTION

1. Field of the Invention

The present invention relates to a vertical blind and, more specifically, to a control box for vertical blind.

2. Description of the Related Art

A conventional vertical blind, as shown in FIG. 1, comprises a headbox 1, a set of slats 2, and a control box 3. The control box 3 has a control rod 4 at the bottom side for operation by hand to rotate the slats 2 to the desired angle. Because the control rod 4 is vertically downwardly extended from the control box 3, the vertical outer side edge of the lateral slat 2 will touch the control rod 4. Therefore, the lateral slat 2 cannot be fully closed. When the slats turned to the close position, a gap 5 is left between each two adjacent slats 2 (see FIG. 2). Further, when tilting the control rod 4 rightwards in order to prevent contact between the control rod 4 and the lateral slat 2 during rotation of the slats 2, as shown in FIG. 3, light will still pass through the gaps in the vertical blind into the indoor space because a distance 7 is produced between the control box 3 and the seal 6 in this case (see FIG. 3). According to human nature, the user tends to tilt the control rod 4 before rotating it to adjust the slats 2. In case the control rod 4 is limited to rotary motion, tilting the control rod 4 will cause the control rod 4 to break.

### SUMMARY OF THE INVENTION

It is the main object of the present invention to provide a control box for vertical blind, which enables the slats to be smoothly rotated to the full close position to completely block light.

It is another object of the present invention to provide a control box for vertical blind, which is orthopedically engineered to fit human nature for smooth operation.

According to the present invention, the control box is installed in a headbox of a vertical blind and driven by a control rod to rotate a toothed axle in the headbox to further control the angular positions of slats of the vertical blind. The control box has a lower part thereof tilted to keep the control rod which is coupled to the lower part of the control box away from the adjacent slat at a distance, preventing contact of the adjacent slat with the control rod during rotary motion of the slats.

### BRIEF DESCRIPTION OF THE DRAWINGS

FIG. 1 is a perspective view of a vertical blind according to the prior art.

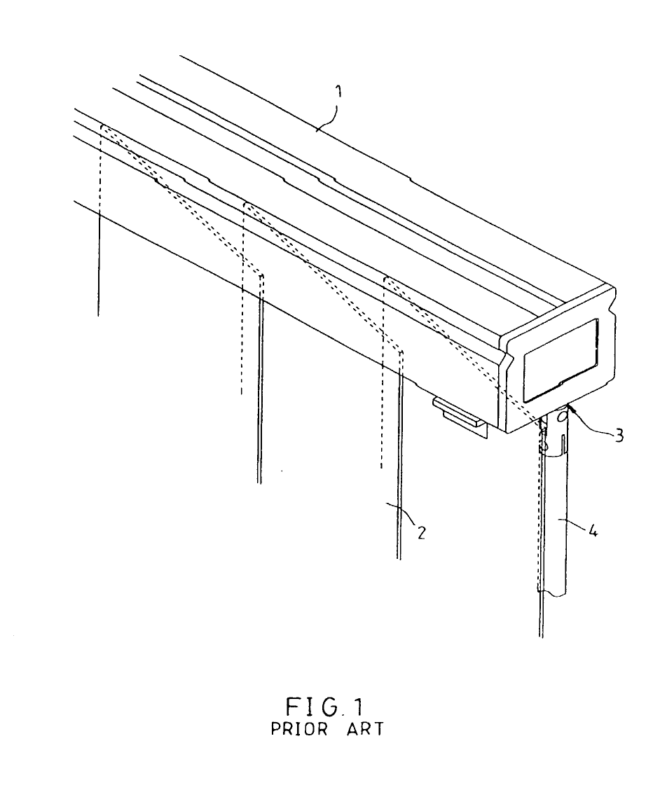

FIG. 2 is a top view showing the slats rotated to one operation status of the prior art vertical blind.

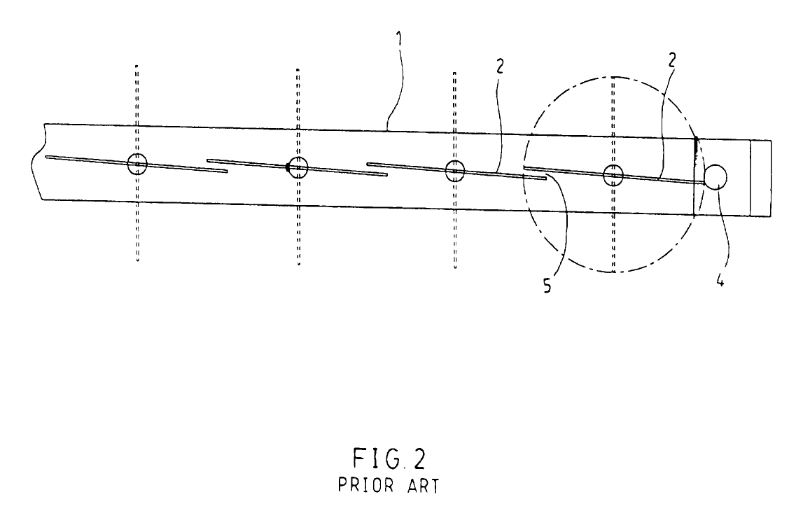

FIG. 3 is a top view showing another operation status of the prior art vertical blind.

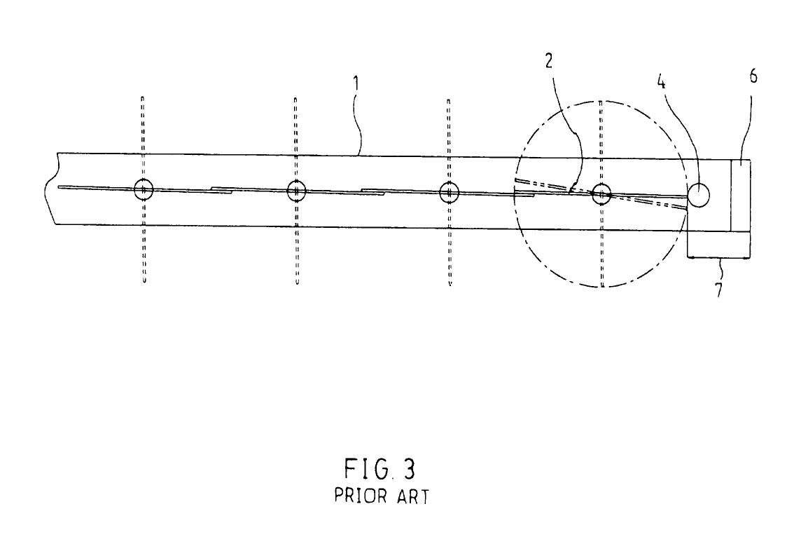

FIG. 4 is a perspective view showing a control box installed in the headbox of a vertical blind according to the present invention.

FIG. 5 is a side view in section in an enlarged scale of FIG. 4.

FIG. 6 shows an operation status of the vertical blind according to the present invention.

FIG. 7 is a schematic drawing of an alternate operation status of the present invention.

### DETAILED DESCRIPTION OF THE PREFERRED EMBODIMENT

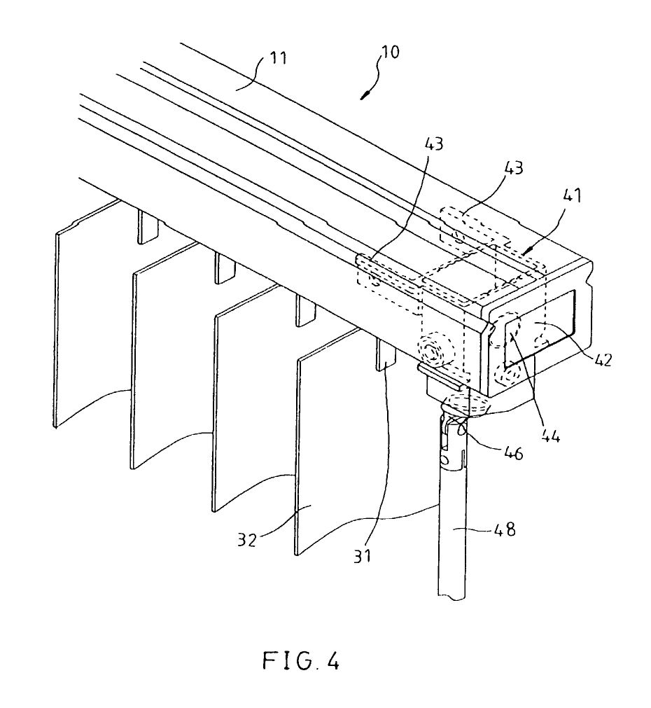

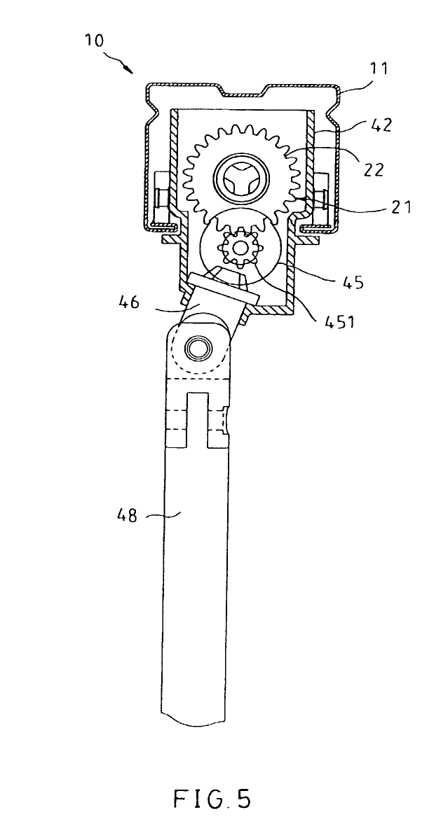

Referring to FIGS. 4 and 5, a vertical blind 10 is shown comprising a headbox 11, a toothed axle 21, a set of carriers 31, and a control box 41.

The headbox 11 is an extruded member shaped like a long, rectangular box having the bottom side and the two opposite ends opened.

The toothed axle 21 is a round rod mounted in the headbox 11, having gear grooves 22 equiangularly spaced around the periphery.

The carriers 31 respectively sleeved onto the toothed axle 21 in the headbox 11 in proper order, each carrying a respective slat 32.

The control box 41 comprises a casing 42 mounted in one end of the headbox 11, the casing 42 having a through hole 44, which receives one end of the toothed axle 21, two mounting arms 43 bilaterally extended from the casing 42 toward the inside of the headbox 11 and adapted for fastening to the lateral carrier 31 and holding the lateral carrier 31 away from the casing 42 at a distance, a driven gear 45 mounted inside the casing 42, a small gear 451 formed integral with one side of the driven gear 45 and meshed with the gear grooves 22 of the toothed axle 21, and a worm 46 meshed with the driven gear 45 at a tilted angle over 20° and a control rod 48 pivoted to a bottom side of the worm 46. When the user rotating the control rod 48, the worm 46 is forced to rotate the driven gear 45, thereby causing the small gear 451 to rotate the toothed axle 21 to further cause the slats 32 to be rotated to the desired angle.

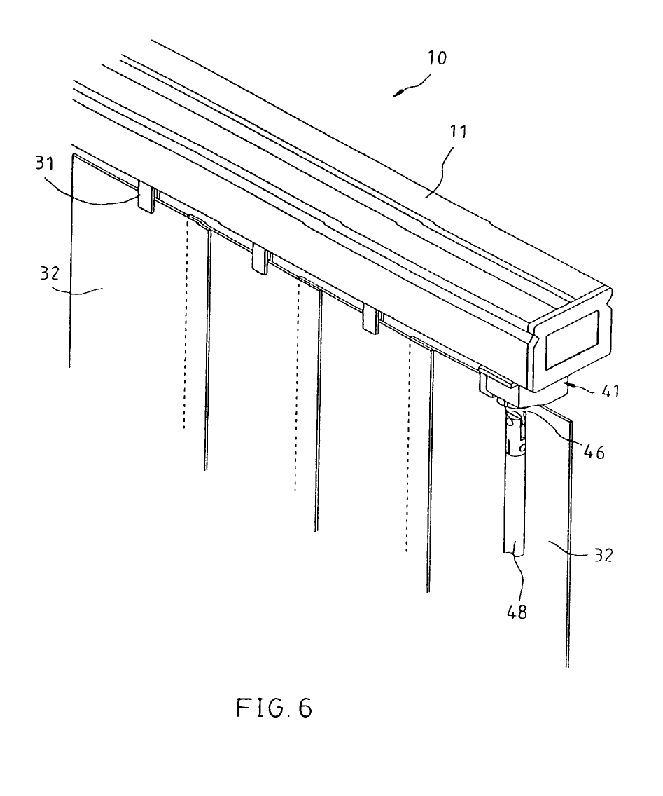

Referring to FIG. 6, because the worm 46 is meshed with the driven gear 45 at a tilted angle over 20° the control rod 48 is kept away from the lateral slat 32 at a predetermined distance sufficient for enabling the lateral slat 32 to be freely rotated without touching the control rod 48.

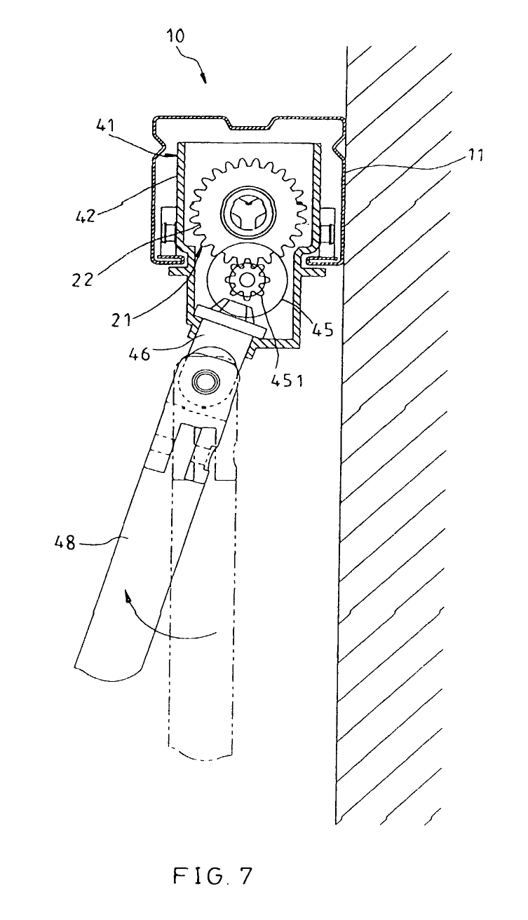

Referring to FIG. 7, the casing 42 of the control box 41 can be fixedly fastened to the inside of the headbox 11 at a tilted angle, enabling the control rod 48 to be conveniently operated with the hand.

Furthermore, the mounting arms 43 of the control box 41 can be made having a respective longitudinal sliding slot (not shown) respectively coupled to the lateral carrier 31, for enabling the lateral carrier 31 to be moved relative to the casing 42 within the limit of the longitudinal sliding slot of each mounting arm 43.

What the invention claimed is:

1. A control box adapted to be installed in a headbox of a vertical blind, said vertical blind having a toothed axle rotatably mounted in the headbox, a set of carriers mounted on the tooth axle, a plurality of vertical slats respectively coupled to the carriers and a control rod coupled to the control box for controlling the rotation of the slats, said control box comprising:
a casing mounted in one end of said headbox, said casing having a through hole, which receives one end of said toothed axle, a driven gear mounted inside said casing, a small gear fixedly connected to one side of said driven gear and meshed with said toothed axle, and a worm meshed with said driven gear at a tilted angle over 20° and coupled to said control rod for rotation with said control rod.

2. The control box as claimed in claim 1, wherein said casing comprises two mounting arms extended from two sides thereof toward the inside of said headbox and adapted for fastening to one of said carriers.

3. The control box as claimed in claim 2, wherein said mounting arms each have a longitudinal sliding slot respectively coupled to the carrier.

4. The control box as claimed in claim 1, wherein said worm has a bottom side coupled to a top side of said control rod.
